(19) United States
(12) Patent Application Publication
(10) Pub. No.: US 2016/0207241 A1
(43) Pub. Date: Jul. 21, 2016

(54) COMPOUNDER-INJECTION-MOLDING UNIT

(71) Applicant: HP PELZER HOLDING GMBH, Witten (DE)

(72) Inventors: Joerg GERIGK, Dorsten (DE); Tariq OWEIMREEN, Denver, CO (US); Volkmar SCHULZE, Schierling (DE); Thomas KARCZ, Dortmund (DE); Thomas BUCKI, Dorsten (DE); Norbert NICOLAI, Schermbeck-Gahlen (DE)

(73) Assignee: HP PELZER HOLDING GMBH, Witten (DE)

(21) Appl. No.: 14/914,873

(22) PCT Filed: Sep. 5, 2014
(86) PCT No.: PCT/EP2014/068968

§ 371 Date: Feb. 26, 2016

(30) Foreign Application Priority Data
Sep. 11, 2013 (DE) 10 2013 218 193.0

(51) Int. Cl. B29C 45/47; B29C 45/77

(52) U.S. Cl. CPC B29C 45/47; B29C 45/77; B29C 2045/466

(57) ABSTRACT

The invention concerns a compounder-injection-molding unit, wherein a continuously operating compounder is coupled to a discontinuously operating screw injection-molding machine.

### FIELD OF THE INVENTION

The invention relates to a compounder-injection-molding unit in which a continuously working compounder is coupled with a discontinuously working screw-type injection molding machine.

### BACKGROUND

Different designs of injection units coupled with a compounding unit are known from the prior art. The compounder is preferably a twin-screw extruder, which is co-rotating or counter-rotating depending on the type of material. The injection unit is preferably a piston-type injection molding machine. Solutions in which the compounder works continuously and the injection molding machine works discontinuously are applied in practice. During the injection process, the injection molding machine cannot take up material. The storage or processing of the material then distinguishes the individual solutions.

A compounder-injection-molding unit in which 2 injection molding machines are alternately supplied with the melt by a continuously working twin-screw extruder is known from EP 1 144 174 B1.

The first in/first out is achieved here by a flow that continuously goes in one direction.

Another solution is known from EP 1 306 187 B1. In this solution, a material reservoir is provided between the injection molding unit and the compounder. A stop valve towards the reservoir prevents backflow during the injection process.

EP 1 333 968 B1 and U.S. Pat. No. 2,950,501 A describe a solution in which a defined cleft between the piston and cylinder serves for the continuous transport of the melt into the injection space. A uniform filling is to be achieved through manifold channels.

In EP 2 050 554 A1, a compound is conveyed into the injection machine under counter-pressure with corresponding screw geometries.

In U.S. Pat. No. 6,875,385 B2, a fibrous material is coated with a melt under pressure.

Johannaber, F.; “Injection molding machines: a user's guide”, Carl Hanser publishers, Munich, Vienna, New York, 1994, pages 242 and 243, relates to general prior art.

In WO 2009/147227 A1, in a similar solution, the material is conveyed into the injection space through channels in the piston or cylinder. The realization of the first in/first out principle is said to be advantageous over the aforementioned solution.

In another embodiment, WO 01/78963 A1 describes an injection unit for a piston-type injection molding machine with an extruder as the plastification unit. The front end of the extruder is connected with the injection space of the piston-type injection unit through a melt line. The melt line has a stop valve. When the stop valve is closed, the back-pressure length increases backwards into the extruder.

### SUMMARY OF THE INVENTION

It is the object of the present invention to provide a compounder-injection-molding unit consisting of commercially available components (plants) without substantial reconstruction in which the continuously obtained homogeneous compound melt is continuously stored in a discontinuously working screw-type injection molding machine 2 during the injection molding process, or buffered in such a way that the reservoir 10 is emptied completely in the next injection molding cycle.

In the broadest sense the present invention concerns a compounder-injection-molding unit comprising a compounder (1), especially a twin-screw extruder, for producing a materially and thermally homogeneous compound melt of at least one plastic material and further additives; and a screw-type injection molding machine

(2) with a standard feed zone (6),
characterized in that
the exit of the compounder (1) is directly connected with the standard feed zone (6) of the screw-type injection molding machine (2) through a connecting unit (8) without counter-pressure from the screw-type injection molding machine (2),
said injection molding machine (2) has a feed space as a reservoir (10) for a compound continuously produced by the compounder (1); and
a sensor (7) of compounder (1) for measuring the filling level.

### DESCRIPTION OF THE PREFERRED EMBODIMENTS

The invention relates to a compounder-injection-molding unit comprising a compounder 1, especially a twin-screw extruder 3, for producing a homogeneous melt of at least one plastic material and further additives, and a screw-type injection molding machine 2 connected with compounder 1.

The connection of the compounder 1 to the injection molding machine 2 can be realized in different zones of the cylinder of the injection molding machine 2. According to the invention, the compounder 1 is connected with the injection molding machine 2 in such a way that the zone of the injection molding screw 5 from the material supply from the compounder 1 to the standard material providing part 6 (standard hopper of the screw-type injection molding machine 2) represents a reservoir 10 for the material continuously produced by compounder 1.

In a first embodiment, the present invention relates to a compounder-injection-molding unit comprising a compounder 1, especially a twin-screw extruder 3, for producing a materially and thermally homogeneous compound melt 12 of at least one plastic material and further additives; and a screw-type injection molding machine 2 with a standard feed zone 6,

characterized in that
the exit of the compounder 1 is directly connected with the standard feed zone 6 of the screw-type injection molding machine 2 through a connecting unit 8 without counter-pressure from the screw-type injection molding machine 2,
said injection molding machine 2 has a feed space as a reservoir 10 for a compound continuously produced by the compounder 1; and a sensor 7 of compounder 1 for measuring the filling level.

In a particular embodiment, the material from the compounder 1 is directly introduced into the standard hopper of the injection molding machine 2 without a rigid coupling; and the metering space acts as a material reservoir 10. Thus, the material 12 relaxes into a pressureless state, but is naturally recompacted towards the screw tip, i.e., the congestion space or prescrew space 11.

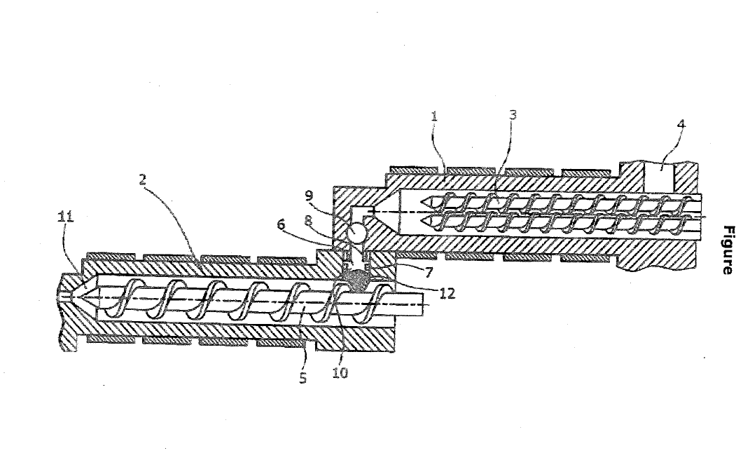

In the following, the operation of the device according to the invention is described with reference to FIG. 1.

The compounder 1 starts the production of a compound. The materials to form the compound are introduced through compounder opening 4.

The compound is discharged through the start-up valve 9 until some material and thermal homogeneity has been reached.

When the start-up valve 9 is closed, the materially and thermally homogeneous compound 12 (compound melt) is conveyed into the screw-type injection molding machine 2. The screw 5 of the injection molding machine 2 start to rotate. The rotational movement of the screw 5 conveys the compound 12 forward, in front of the screw tip, into the congestion space or prescrew space 11 until sufficient compound for the injection process has accumulated. Because of the pressure building up in the congestion space or prescrew space 11, the compound 12 in the screw 5 is axially compressed.

By axially displacing the screw 5 towards the nozzle while the non-return valve 9 is closed, the compound is injected into the mold cavity with high pressure through the nozzle and the feed channel.

During this time, the screw flights of screw 5 that are provided downstream of connecting unit 8 towards the standard feed zone 6 of compounder 1 and injection molding machine 2 are filled with new compound from the compounder 1. At that time, the screw 5 does not rotate.

In the following cycle, the screw 5 begins to rotate again; the metering process starts again. This solution according to the invention in which the connecting. unit 8 is not within the standard feed zone 6 of the screw 5, but in the zone of the first third to one quarter of the length of screw 5 in the conveying direction from standard feed zone 6, achieves by continuous compound feeding at any rate that all the compound is injected/metered out in the next injection molding cycle, and old compound cannot accumulate.

At the standard feed zone 6 of the injection molding machine 2, a sensor 7 is preferably provided on the one hand, which monitors the filling level of the injection molding machine 2 and turns off the compounder 1 when the provided reservoir 10 is exceeded. On the other hand, or simultaneously, this zone is applied with vacuum in a specific embodiment.

For air-sensitive materials, this zone may be purged with protective gas.

In a specific embodiment, the compound is directly extruded into the standard feed zone 6 of the injection molding machine 2. The compounder 1 is started with the production of compound. The compound is discharged through the start-up valve 9 until material and thermal homogeneity has been obtained. Upon the closing of the start-up valve 9, compound is conveyed into the standard feed zone 6 of the injection molding machine 2, and the screw 5 begins to rotate. All the compound is conveyed forward thereby, in front of the screw tip, into the congestion space or prescrew space 11, until sufficient melt for the injection process has accumulated. Because of the pressure building up in the congestion space or prescrew space 11, the screw 5 is axially compressed.

By axially displacing the screw 5 towards the nozzle while the non-return valve is closed, the compound is injected into the mold cavity with high pressure through the nozzle and the feed channel. During this time, the standard feed zone 6 is used as a reservoir for the compound. At that time, the screw 5 does not rotate.

In the following cycle, the screw 5 begins to rotate again, and all the compound is conveyed forward thereby, in front of the screw tip, into the congestion space or prescrew space 11, until sufficient compound for the injection process has again accumulated.

By axially displacing the screw 5 towards the nozzle while the non-return valve is closed, the compound is injected into the mold cavity with high pressure through the nozzle and the feed channel.

This solution always conveys all the compound in every shot forward, thus realizing the first in/first out principle.

A sensor 7 in the standard feed zone 6 monitors the filling level, and the compounder 1 is controlled accordingly. In a specific embodiment, this zone is applied with vacuum. For air-sensitive materials, this zone may be purged with protective gas.

### EXAMPLE

A commercially available injection molding machine from the company Engel, Schwertberg, Austria, of the type Engel Duo 23000-17290 and a twin-screw extruder (compounder) from the company Coperion, Stuttgart, Germany, of the type STS-65 with a processing section length of 40 D were employed. The twin-screw extruder had a screw configuration that was common for incorporating fillers, and possessed gravimetric dosing.

Through this gravimetric dosing, the formulation, which consisted of 65% by weight mineral filler (baryte), 17% by weight thermoplastic olefins (TPO) (Engage), 17% by weight polypropylene (PP) and 1% by weight usual thermal stabilizers, was metered into the twin-screw extruder with a discharge rate of 300 kg/h.

The two machines are connected through a short melt line/connecting unit, in which a start-up valve is integrated. Through this start-up valve, the start-up material is discharged into a quenching tank, which is positioned below the start-up valve.

Now, when the signal “formulation o.k.” was reported by the gravimetric dosing, the start-up valve closed after a defined period of time in order to ensure that no undefined, non-homogeneous compound is guided into the injection molding process.

Upon the closing of the start-up valve, the dosing screw of the injection molding machine began to rotate and metered the compound forward and then pressed it into an injection mold.

During the injection and forward pressing sequence, the compound produced by the twin-screw extruder was buffered in the free volume between the connecting unit and the standard feed zone of the metering screw of the injection molding machine, and then conveyed completely into the congestion space or prescrew space of the injection molding machine in the next cycle.

In this application case, the injection mold was a bulkhead mold for preparing acoustic components for the automobile industry.

However, after corresponding adaptations of the screw geometry and formulation, the above Example can be applied to any product on the plant in principle for which the compounding of a material is economically efficient.

### LIST OF REFERENCE SYMBOLS

1 compounder
2 injection molding machine
3 compounder twin screw
4 compounder metering opening
5 injection molding machine screw
6 injection molding machine standard feed zone
7 sensor/measuring of filling level
8 connecting unit
9 start-up valve
10 reservoir
11 congestion space or prescrew space
12 injection molding material

1. A compounder-injection-molding unit comprising a compounder (1), especially a twin-screw extruder, for producing a materially and thermally homogeneous compound melt of at least one plastic material and further additives; and a screw-type injection molding machine (2) with a standard feed zone (6),
characterized in that
the exit of the compounder (1) is directly connected with the standard feed zone (6) of the screw-type injection molding machine (2) through a connecting unit (8) without counter-pressure from the screw-type injection molding machine (2),
said injection molding machine (2) has a feed space as a reservoir (10) for a compound continuously produced by the compounder (1);
a conveying screw (5) positioned within the screw-type injection molding machine (2); and
said injection molding machine (2) has a sensor (7) for measuring the filling level of the injection molding machine (2) and controlling the operation of compounder (1).

2. The compounder-injection-molding unit according to claim 1, characterized in that
the screw (5) communicates with the connecting unit (8) via the standard feed zone (6) which is designed in such a way that the compound present in the reservoir (10) is always metered completely into the subsequent injection molding cycle/metering cycle of the injection molding machine (2).

3. The compounder-injection-molding unit according to claim 1,
characterized in that
the connecting unit (8) has a valve (9) for discharging inhomogeneous compound during the start-up and of any compound that is not needed.

4. The compounder-injection-molding unit according to claim 1, characterized in that
the connecting unit (8) is positioned along the cylinder of the screw-type injection molding machine (2) in the zone of the first third of the screw (5) in the conveying direction from the standard feed zone (6).

5. The compounder-injection-molding unit according to claim 1
characterized in that
a filling level sensor (7) is provided in the standard feed zone (6) of the screw-type injection molding machine (2).

6. The compounder-injection-molding unit according to claim 1, characterized in that
the channel volume of the screw (5) is adapted to the metering volume.

7. The compounder-injection-molding unit according to claim 1, characterized in that
the compound is directly conveyed into the standard feed zone (6) of the screw-type injection molding machine (2), and the controlling is effected through a filling level sensor (7).
